(19) United States
(12) Patent Application Publication
(10) Pub. No.: US 2006/0216421 A1
(43) Pub. Date: Sep. 28, 2006

(54) Aqueous ink for mimeograph printing and method for mimeograph printing

(76) Inventors: Yoshihiro Hayashi, Ibaraki-ken (JP); Hiroshi Hayashi, Ibaraki-ken (JP); Yoshifumi Watanabe, Ibaraki-ken (JP)

Correspondence Address: NATH & ASSOCIATES, 112 South West Street, Alexandria, VA, 22314, US

(21) Appl. No.: 10/571,759

(22) PCT Filed: Jul. 30, 2004
(86) PCT No.: PCT/JP04/10950

§ 371 Date: Mar. 13, 2006

(30) Foreign Application Priority Data
Sep. 30, 2003 (JP) 2003-340160

(51) Int. Cl. B05D 1/32; C08K 5/05

(52) U.S. Cl. 427/282; 524/386; 523/160

(57) ABSTRACT

A water-based ink for stencil printing, which comprises an unsaturated carboxylic acid-based water-soluble polymer and triethylene glycol. The ink preferably further comprises β-thiodiglycol as an optional component.

### TECHNICAL FIELD

The present invention relates to a water-based ink for stencil printing, and more particularly to a water-based ink for stencil printing that is suitable for use in a rotary digital stencil printing machine, as well as a stencil printing method that uses such an ink.

### BACKGROUND ART

Compared with other printing methods such as offset printing, gravure printing, and letterpress printing, stencil printing offers significant advantages in terms of operability and convenience, including not requiring complex operations such as post-use cleaning operations, and not requiring a specialist operator. Since the introduction of thermal stencil making methods that use a thermal head as a perforation device, image processing within stencil printing methods has been able to be digitalized, enabling high quality printed products to be produced quickly and with comparative ease, and consequently the convenience of stencil printing continues to gain recognition, even as a method for information processing terminals.

Rotary stencil printing machines, in which the making, loading, and removal operations for the master, as well as the ink supply operation and the printing operation are all controlled automatically, are widely used in offices and schools under names such as digital stencil duplicators.

Inks for stencil printing have conventionally been water-in-oil (W/O) emulsion inks. W/O emulsion inks have a function that inhibits variations in the ink composition or the ink properties when the printing machine is sitting unused, even if the ink inside the machine is in contact with the atmosphere. In other words, the water, which is the inner phase component of the emulsion ink, is covered with the outer phase oil component, meaning evaporation of the water is inhibited.

It is thought that the drying of printed material that has been printed using a W/O emulsion ink proceeds by a mechanism that relies on the penetration of the ink into the gaps between the fibers of the paper that functions as the print target (the print medium), and the gradual separation of the ink into an oil phase and a water phase as a result of contact with the paper fibers, thus enabling the water, which represents the major component of the ink, to contact the atmosphere and evaporate. However, the water within the ink transferred to the print medium is unable to undergo adequate contact with the atmosphere in the short period of time following printing, meaning the drying characteristics immediately following printing rely on drying by penetration. However, because the viscosity of a W/O emulsion ink is designed to be relatively high, the rate of penetration is not particularly fast, meaning the drying characteristics of the ink immediately following printing are not entirely satisfactory.

Improving the drying rate of printed material is an extremely important problem for stencil printing. If the printed material is not dry, the operator is unable to handle the material, and the advantage of stencil printing of “producing high quality printed material in a short time” is partially negated.

Accordingly, a variety of improvements have been proposed for enhancing the drying characteristics of the printed material, and for example, ultraviolet curing inks for stencil printing that undergo fixation and drying-upon irradiation with ultraviolet light are already known (see Japanese Laid-Open Publication No. 2002-30238). Furthermore, water-based inks for stencil printing are also being developed due to their improved environmental friendliness and safety, and a stencil printing method in which a base is applied to the printed surface immediately following printing, thereby improving the penetration of the water-based ink into the paper, is already known (see Japanese Laid-Open Publication No. 2001-302955).

However, in those cases where a drying method that uses a chemical reaction is used, an irradiation device for providing the curing energy and an application device for the reaction liquid are required, as is the energy for those devices, and expensive raw materials must also be included within the ink.

On the other hand, with conventional water-based inks for stencil printing, if the printing machine is left in an unused state, and the ink inside the printing machine is left in an open system for an extended period, then the ink loses fluidity. As a result, the printing operability deteriorates after the printing machine has been left sitting unused for an extended period, and if the printing machine is not disassembled and cleaned, either immediately after printing or immediately prior to recommencing printing, then recommencing printing operations may become impossible, which significantly impairs the advantage of stencil printing of providing “favorable operability and workability”.

Accordingly, an object of the present invention is to provide a water-based ink for stencil printing which exhibits favorable operability and workability during printing, and exhibits excellent drying characteristics of the printed material without requiring the use of special devices, apparatus, or energy or the like, such as the provision of heat, light, or reactive substances, as well as a stencil printing method that uses such an ink.

### DISCLOSURE OF INVENTION

The present invention relates to a water-based ink for stencil printing that comprises an unsaturated carboxylic acid-based water-soluble polymer and triethylene glycol.

Another aspect of the present invention relates to a stencil printing method that uses a water-based ink for stencil printing according to the above aspect of the present invention.

### BEST MODE FOR CARRYING OUT THE INVENTION

A water-based ink for stencil printing (hereafter, the term “water-based ink for stencil printing” is abbreviated as simply “ink”) according to the present invention comprises water, a water-soluble organic solvent, a colorant, and a thickener, wherein triethylene glycol is added as the water-soluble organic solvent. From the viewpoint of maintaining favorable ink fluidity after the printing machine has been left sitting for an extended period, the quantity of triethylene glycol within the ink is preferably at least 12.5% by weight, and is even more preferably 15% by weight or higher. Although there are no particular restrictions on the upper limit for the blend quantity of triethylene glycol, in order to limit image show through, the quantity is preferably no more than approximately 45% by weight, and even more preferably 35% by weight or less.

In addition to the triethylene glycol, β-thiodiglycol [S(CH₂CH₂OH)₂; 2,2′-thiodiethanol] is preferably also incorporated in the ink. Incorporating diethylene glycol is also desirable. In other words, β-thiodiglycol and/or diethylene glycol are preferably used in combination with the triethylene glycol. In such cases, from the viewpoint of maintaining favorable ink fluidity after the printing machine has been left sitting for an extended period, the combined quantity of these materials is preferably at least 12.5% by weight, and is even more preferably 15% by weight or higher. Although there are no particular restrictions on the upper limit for the combined blend quantity of these materials, in order to limit image show through, the combined quantity is preferably no more than approximately 45% by weight, and even more preferably 35% by weight or less.

In addition, other water-soluble organic solvents may also be used. Examples of these other water-soluble organic solvents include organic compounds that are liquid at room temperature and soluble in water. Suitable examples include lower alcohols such as methanol, ethanol, 1-propanol, isopropanol, 1-butanol, 2-butanol, isobutanol, and 2-methyl-2-propanol; glycols such as ethylene glycol, tetraethylene glycol, pentaethylene glycol, propylene glycol, dipropylene glycol, and tripropylene glycol; glycerol; acetins (monoacetin, diacetin, and triacetin); glycol derivatives such as triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; as well as triethanolamine and sulfolane. Low molecular weight polyalkylene glycols, including polyethylene glycol with an average molecular weight within a range from 190 to 630, such as an average molecular weight of 200, 300, 400, or 600, polypropylene glycol diol with an average molecular weight within a range from 200 to 600, such as an average molecular weight of 400, and polypropylene glycol triol with an average molecular weight within a range from 250 to 800, such as an average molecular weight of 300 or 700, can also be used. These water-soluble organic solvents can be used either alone, or in combinations of two or more different solvents.

Generally it is thought that in an open system, even inside a stencil printing machine, even a water-soluble organic solvent will gradually evaporate into the atmosphere, depending on the nature of the solvent, meaning any ink that is left to sit inside a printing machine will eventually solidify. Alternatively, it is thought that a water-soluble organic solvent will be absorbed into the Japanese paper fibers of any master left on the printing machine drum, meaning the ink inside the printing machine will solidify. In addition, there is the danger that once the water has evaporated from the ink, the colorant will aggregate.

In contrast, triethylene glycol does not evaporate into the atmosphere, even if left to sit for extended periods, is resistant to absorption into the Japanese paper fibers of any master left on the printing machine drum, and is able to prevent aggregation of the colorant. Consequently, it is thought that an ink that includes this type of water-soluble organic solvent will retain its fluidity and inhibit solidification, even if left to sit inside the printing machine.

The liquid component of the ink is a mixture of water and the water-soluble organic solvent. When a water-soluble organic solvent is mixed with water, the viscosity of the mixed liquid is always low, regardless of the size of the viscosity of the water-soluble organic solvent. In other words, the viscosity of the liquid component of the ink is almost unaffected by the viscosity of the water-soluble organic solvent, and the desired ink viscosity can be obtained whether a low viscosity water-soluble organic solvent is used or a high viscosity water-soluble organic solvent is used. On the other hand, when the ink is left to sit inside a printing machine and the water evaporates, the viscosity of the liquid component of the ink approaches the viscosity of the water-soluble organic solvent. Accordingly, it is thought that by using triethylene glycol, which represents a water-soluble organic solvent of low viscosity, any increase in the viscosity of the liquid component of the ink following evaporation of the water can be suppressed, enabling the fluidity of the ink inside the printing machine to be maintained.

From the viewpoint of improving the drying characteristics of the printed material, water preferably accounts for at least 50% by weight, and even more preferably 65% by weight or more, of the ink. The water contained within the ink can evaporate into the atmosphere immediately following printing. In addition, it is thought that by forcing the ink to penetrate into the gaps between the fibers of the printing paper during printing, the contact surface area between the ink and the air expands rapidly within the interior of the printing paper, further improving the evaporation rate of the water, and as a result, increasing the quantity of water further improves the drying characteristics of the printed material. Although there are no particular restrictions on the upper limit for the blend quantity of the water, the quantity is preferably set to ensure a favorable balance with the other components of the ink.

The colorant can use either pigments or dyes, or a combination of two or more such colorants. Suitable pigments include organic pigments such as azo-based pigments, phthalocyanine-based pigments, dye-based pigments, condensed polycyclic pigments, nitro-based pigments, and nitroso-based pigments (such as brilliant carmine 6B, lake red C, Watchung red, disazo yellow, Hansa yellow, phthalocyanine blue, phthalocyanine green, alkali blue, and aniline black); inorganic pigments, including metals such as cobalt, iron, chrome, copper, zinc, lead, titanium, vanadium, manganese, and nickel, as well as metal oxides, metal sulfides, yellow ocher, ultramarine, and iron blue pigments; and carbon blacks such as furnace carbon black, lamp black, acetylene black, and channel black. Suitable dyes include those basic dyes, acid dyes, direct dyes, soluble vat dyes, acid mordant dyes, mordant dyes, reactive dyes, vat dyes, and sulfide dyes that are water soluble, as well as those dyes that have been converted to a water-soluble form through reduction or the like. Either pigments and/or dyes can be used as the colorant, but the use of pigments is preferred, as they enable production of an ink that exhibits minimal bleeding or image show through, and excellent weather resistance.

The quantity of colorant within the ink is typically within a range from 1 to 15% by weight, and preferably from 3 to 12% by weight. In order to maximize the print density of the printed material, the colorant quantity is preferably at least 5% by weight. Even if the ink contains 5% by weight or more of colorant, aggregation of the colorant when the printing machine is left in an unused state for an extended period can still be prevented, enabling an improvement in the printing operability. If the quantity of colorant exceeds 15% by weight, then there is a danger that the printing performance may deteriorate after the printing machine has been left in an unused state.

From the viewpoints of preventing aggregation of the colorant and maintaining the fluidity of the ink, the quantity of triethylene glycol, or the combined quantity of triethylene glycol, β-thiodiglycol and/or diethylene glycol is preferably at least twice the weight of the quantity of colorant, and although there are no particular restrictions on the upper limit, the quantity is preferably no more than 20 times, and most preferably from 2.5 to 6.0 times the weight of the colorant.

An unsaturated carboxylic acid-based water-soluble polymer is added as a thickener. An unsaturated carboxylic acid-based water-soluble polymer refers to a water-soluble polymer comprising a repeating unit represented by a formula (1) shown below: 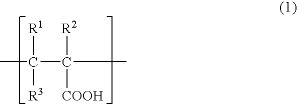
(wherein, R¹, R², and R³ each represent, independently, H, CH₃, or (CH₂)ₙCOOH (wherein, n is either 0 or 1)). In those cases where a polymer contains 2 or more carboxyl groups, these carboxyl groups may also form an acid anhydride group. In the case of a copolymer, a random, alternate, block, or graft copolymer may be used.

Examples of this unsaturated carboxylic acid-based thickener include water-soluble polymers comprising, within the principal chain, one or more unsaturated carboxylic acids selected from the group consisting of acrylic acid, methacrylic acid, maleic anhydride, maleic acid, fumaric acid, crotonic acid, and itaconic acid, as well as the salts thereof. Specific examples include polyacrylic acid, polymethacrylic acid, polycrotonic acid, polyitaconic acid, polymaleic acid, polyfumaric acid, acrylic acid-methacrylic acid copolymers, acrylic acid-itaconic acid copolymers, acrylic acid-maleic acid copolymers, acrylic acid-acrylate ester copolymers, acrylic acid-methacrylate ester copolymers, and acrylic acid-sulfonic acid-based monomer copolymers. These polymers can be used either alone, or in combinations of two or more different polymers.

Because these unsaturated carboxylic acid-based thickeners are electrolyte thickeners with a plurality of dissociable groups on side chains, and are capable of providing the desired thickening effect even with small quantities, the blend quantity of the thickener can be kept small. Furthermore, even if left to sit inside a printing machine, the thickener does not cause solidification of the ink.

In this description, the unsaturated carboxylic acid-based water-soluble polymer includes not only the unneutralized polymers described above, but also neutral salts of the above polymers. Examples of these neutral salts include salts of alkali metals such as sodium and potassium, ammonium salts, and salts of alkanolamines such as triethanolamine, and specific examples of favorable salts include sodium polyacrylate, potassium polyacrylate, ammonium polyacrylate, triethanolamine polyacrylate, sodium polymethacrylate, ammonium polymethacrylate, sodium polyitaconate, sodium polymaleate, the sodium salt of an acrylic acid-methacrylic acid copolymer, and the sodium salt of an acrylic acid-maleic acid copolymer.

The quantity added of the above thickener varies depending on factors such as the chemical structure of the thickener and the desired ink viscosity, but in order to achieve stable ink properties, is preferably at least 0.01% by weight, and in order to ensure a favorable balance with the other components of the ink and ensure favorable printing operability following the printing machine being left in an unused state, is preferably no more than 5% by weight, and is even more preferably within a range from 0.05 to 3% by weight, and most preferably from 0.1 to 2% by weight.

The ink may also comprise one or more other water-soluble polymer-based thickeners or clay mineral-based thickeners, in addition to the aforementioned unsaturated carboxylic acid-based thickener.

Examples of these optional other water-soluble polymer-based thickeners include natural polymers, semisynthetic polymers, and synthetic polymers. Suitable natural polymers include plant-based natural polymers such as gum arabic, carageenan, guar gum, locust bean gum, pectin, tragacanth gum, corn starch, konjac mannan, and agar; microbial natural polymers such as pullulan, xanthan gum, and dextrin; and animal-based natural polymers such as gelatin, casein, and animal glue. Suitable semisynthetic polymers include cellulose-based semisynthetic polymers such as ethylcellulose, carboxymethylcellulose, hydroxyethylcellulose, hydroxypropylcellulose, methylcellulose, and hydroxypropylmethylcellulose; starch-based semisynthetic polymers such as hydroxyethyl starch, sodium carboxymethyl starch, and cyclodextrin; alginate-based semisynthetic polymers such as sodium alginate and propylene glycol alginate; and sodium hyaluronate. Suitable synthetic polymers include vinyl-based synthetic polymers such as polyvinylpyrrolidone, polyvinyl alcohol, polyvinyl methyl ether, poly-N-vinylacetamide, and polyacrylamide; as well as polyethylene oxide, polyethyleneimine, and polyurethane.

Examples of clay mineral-based thickeners include smectite-based clay minerals such as montmorillonite, hectorite, and saponite.

The blend quantity of these optional thickeners other than the unsaturated carboxylic acid-based thickener is typically no more than 10% by weight, and preferably no more than 5% by weight, and most preferably 2% by weight or less.

The ink may also include suitable quantities of pigment dispersing agents, fixing agents, antifoaming agents, surface tension reduction agents, pH regulators, antioxidants, and preservatives, in addition to the components described above.

An alkali-soluble resin may also be added to the ink as a fixing agent for improving the fixation of the colorant to the print target such as the printing paper. In those cases where a pigment is used as the colorant, an alkali-soluble resin can also be used as a pigment dispersing agent.

Examples of suitable alkali-soluble resins include styrene-acrylic acid copolymers, styrene-a-methylstyrene-acrylic acid copolymers, styrene-methacrylic acid copolymers, styrene-acrylate ester-acrylic acid copolymers, styrene-maleic anhydride copolymers, vinylnaphthalene-acrylic acid copolymers, vinylnaphthalene-maleic acid copolymers, isobutylene-maleic anhydride copolymers, acrylate ester-acrylic acid copolymers, methacrylate ester-acrylic acid copolymers, acrylate ester-methacrylic acid copolymers, methacrylate ester-methacrylic acid copolymers, and acrylate ester-methacrylate ester-acrylic acid copolymers, and a combination of two or more of these resins may also be used. These alkali-soluble resins can be neutralized and converted to a water-soluble form using a suitable alkali, including an alkali metal hydroxide such as sodium hydroxide or potassium hydroxide, ammonia water, or an alkanolamine such as triethanolamine.

If a large quantity of alkali-soluble resin is added, then there is a danger of interfering with the printing performance of the printing machine following a period of non-use, and consequently the quantity of alkali-soluble resin within the ink, calculated as a solid fraction percentage, is preferably no more than 5% by weight, and even more preferably 3% by weight or less.

An oil-in-water (O/W) resin emulsion can also be incorporated within the ink, and used as a fixing agent for fixing the colorant to the printing paper or the like that functions as the print target. In those cases where a pigment is used as the colorant, this resin emulsion can also be used as a pigment dispersing agent.

Examples of suitable oil-in-water (O/W) resin emulsions include emulsions of polyvinyl acetate, ethylene-vinyl acetate copolymers, vinyl acetate-acrylate ester copolymers, polyacrylate ester, polymethacrylate ester, polystyrene, styrene-acrylate ester copolymers, styrene-butadiene copolymers, vinylidene chloride-acrylate ester copolymers, polyvinyl chloride, vinyl chloride-vinyl acetate copolymers, and polyurethane and the like. Combinations of two or more of these emulsions may also be used.

If a large quantity of resin emulsion is added, then there is a danger of interfering with the printing performance of the printing machine following a period of non-use, and consequently the quantity of resin emulsion within the ink, calculated as a solid fraction percentage, is preferably no more than 5% by weight, and even more preferably 2% by weight or less.

The water-soluble polymers listed above as thickeners can also be used as fixing agents for improving the fixation of the colorant to the printing paper, depending on the nature and the quantity of the polymer. Furthermore, in those cases where a pigment is used as the colorant, the water-soluble polymers can also be used as pigment dispersing agents.

Extender pigments may also be added to the ink to improve the image quality of the printed material.

Examples of suitable extender pigments include white clay, talc, clay, diatomaceous earth, calcium carbonate, barium carbonate, barium sulfate, alumina white, silica, kaolin, mica, and aluminum hydroxide, and combinations of two or more of these extender pigments may also be used.

If a large quantity of extender pigment is added, then there is a danger of inhibiting the fixation of the colorant to the print target, and interfering with the printing performance of the printing machine following a period of non-use, and consequently the quantity of extender pigment is preferably no more than 5% by weight, and even more preferably 2% by weight or less.

In addition, anionic surfactants, cationic surfactants, amphoteric surfactants, nonionic surfactants, or polymer-based, silicone-based or fluorine-based surfactants may also be added to the ink as pigment dispersing agents, antifoaming agents, or surface tension reduction agents or the like.

An electrolyte may also be added to the ink to allow regulation of the ink viscosity or pH. Examples of suitable electrolytes include sodium sulfate, potassium hydrogenphosphate, sodium citrate, potassium tartrate, and sodium borate, and combinations of two or more of these electrolytes may also be used. Other materials such as sulfuric acid, nitric acid, acetic acid, sodium hydroxide, potassium hydroxide, ammonium hydroxide, and triethanolamine and the like may also be used in the ink as thickening assistants or pH regulators.

By adding an antioxidant, oxidation of the ink components can be prevented, and the storage stability of the ink can be improved. Examples of suitable antioxidants include Lascorbic acid, sodium L-ascorbate, sodium isoascorbate, potassium sulfite, sodium sulfite, sodium thiosulfate, sodium dithionite, and sodium pyrosulfite.

By adding a preservative, degradation of the ink can be prevented, enabling the storage stability to be improved. Examples of suitable preservatives include isothiazolone-based preservatives such as 5-chloro-2-methyl-4-isothiazolin-3-one, 2-methyl-4-isothiazolin-3-one, 2-n-octyl-4-isothiazolin-3-one, and 1,2-benzoisothiazolin-3-one; triazine-based preservatives such as hexahydro-1,3,5-tris(2-hydroxyethyl)-s-triazine; pyridine or quinoline-based preservatives such as sodium 2-pyridinethiol-1-oxide and 8-oxyquinoline; dithiocarbamate-based preservatives such as sodium dimethyldithiocarbamate; organobromine-based preservatives such as 2,2-dibromo-3-nitrilopropionamide, 2-bromo-2-nitro-1,3-propanediol, 2,2-dibromo-2-nitroethanol, and 1,2-dibromo-2,4-dicyanobutane; as well as methyl p-hydroxybenzoate, ethyl p-hydroxybenzoate, potassium sorbate, sodium dehydroacetate, and salicylic acid.

An ink comprising the aforementioned components can be produced by mixing the water, the triethylene glycol, the colorant, and the unsaturated carboxylic acid-based water-soluble polymer, together with any of the other optional components described above as desired. For example, a portion of the water, the pigment, and the pigment dispersing agent can be mixed together, and a dispersion device such as a ball mill or beads mill then used to disperse the pigment, while the remainder of the water, the thickener, and the triethylene glycol are also mixed together, before the two separate mixtures are then combined and mixed.

The most appropriate range for the ink viscosity varies depending on factors such as the printing pressure of the printing apparatus, but is typically within a range from approximately 0.5 to approximately 20 Pa·s (the viscosity is measured at 20° C., using a shear rate of 100/s), and (pseudo) plastic flow characteristics are ideal for stencil printing.

An ink of the present invention is able to maintain favorable fluidity, even if the printing machine is left in an unused state for an extended period with the ink exposed in an open system inside the printing machine, causing the majority of the water within the ink to be lost to evaporation, and consequently, by using this ink, printing can be conducted without the need to disassemble and clean the printing machine before or after each printing operation, meaning the printing operability of the printing machine following a period of non-use can be significantly improved. In addition, an ink of the present invention exhibits favorable drying characteristics, and so by using this ink, a high quality printed material can be provided that exhibits excellent drying characteristics and is resistant to smudging even if handled immediately following printing. The drying principles utilize mainly the properties of water, and because the drying does not require the use of special devices, apparatus, or energy or the like, such as the provision of heat, light, or reactive substances, the printing apparatus can be reduced in size, the cost of the ink raw materials can be reduced, and superior levels of environmental friendliness and safety can be achieved.

A stencil printing method according to the present invention is conducted using the ink according to the present invention described above. Specifically, the method comprises: preparing a stencil master; and pressing the produced stencil master and a print target together, thereby causing the ink of the present invention to pass through the perforated portions of the stencil master and onto the print target.

There are no particular restrictions on the stencil printing machine used, although because of their superior operability, digital stencil printing machines are preferred.

### EXAMPLES

As follows is a more detailed description of the present invention using a series of examples, although the present invention is in no way limited by these examples. In the following description, the units “% by weight” are abbreviated simply as “%”.

### Example 1

6.0% of carbon black (MCF88, manufactured by Mitsubishi Chemical Corporation) as a colorant, 1.3% of polyvinylpyrrolidone (K90, manufactured by Dai-ichi Kogyo Seiyaku Co., Ltd.) as a pigment dispersing agent, and 20.0% of distilled water were mixed together, and were then dispersed thoroughly using a beads mill, thus yielding a pigment dispersion. 0.5% of polyacrylic acid (Junlon PW150, manufactured by Nihon Junyaku Co., Ltd.) as a thickener was then dissolved in 16.0% of distilled water, and following neutralization of the resulting solution by addition of 10.0% of a 2% aqueous solution of sodium hydroxide, the neutralized solution was combined with the previously prepared pigment dispersion, 16.0% of triethylene glycol, and the remaining quantity of distilled water (30.2%), and the resulting combination was then mixed thoroughly, yielding an ink of the example 1.

### Examples 2 to 6, Comparative Examples 1 to 4

With the exception of using the compositions shown in Table 1, inks for each of the examples and comparative examples were prepared in the same manner as the example 1.

### Comparative Example 5

6.0% of carbon black (the same as the example 1) as a colorant, 1.3% of polyvinylpyrrolidone (the same as the example 1) as a pigment dispersing agent, and 20.0% of distilled water were mixed together, and were then dispersed thoroughly using a beads mill, and to the resulting dispersion were added 0.7% of sodium sulfate as an electrolyte, 4.0% of glycerol as a water-soluble organic solvent, and 46.0% of distilled water, thus yielding a water phase. Meanwhile, a combination of 4.0% of Sunsen oil 4240 (manufactured by Japan Sun Oil Company Ltd.) and 14.0% of AF solvent No. 6 (manufactured by Nippon Oil Corporation) as an oil component, and 4.0% of sorbitan sesquioleate as an emulsifying agent were mixed together, thereby yielding an oil phase. The water phase was then added gradually to the oil phase and emulsified, thus yielding a W/O emulsion ink for stencil printing.

Using each of the inks (the water-based inks for stencil printing) prepared in the examples 1 to 6 and the comparative examples 1 to 4, and the emulsion ink for stencil printing prepared in the comparative example 5, printing was conducted onto printing paper (Riso lightweight paper, manufactured by Riso Kagaku Corporation) using a stencil printing machine (Risograph RP370, manufactured by Riso Kagaku Corporation), and the drying characteristics of the obtained printed material was evaluated. Furthermore, using each of the inks, the printing machine was left to stand in an unused state for a certain period of time following the completion of printing, and the printing was then recommenced, and the printing characteristics on printing recommencement were evaluated. The results of the evaluations for each ink are shown in Table 1.

The drying characteristics were evaluated by touch, and an evaluation of A was recorded if the finger was not soiled even when the printed material was touched 10 seconds following completion of printing, an evaluation of B was recorded if the finger was not soiled after 30 seconds, and an evaluation of C was recorded if the finger was soiled even 30 seconds after the completion of printing.

The operability of the printing machine following a period of non-use was evaluated as A if printing could be recommenced without disassembling and cleaning the printing machine, and evaluated as C is cleaning was required.

TABLE 1

| | | Example | | | | | | Comparative Example | | | | |
|---|---|---|---|---|---|---|---|---|---|---|---|---|
| Blend quantity/% by weight | | 1 | 2 | 3 | 4 | 5 | 6 | 1 | 2 | 3 | 4 | 5 |
| Colorant | Carbon black | 6.0 | 5.0 | 8.0 | 6.0 | 6.0 | 6.0 | 6.0 | 6.0 | 6.0 | 6.0 | |
| Pigment | Polyvinylpyrrolidone | 1.3 | 1.3 | 1.3 | 1.3 | 1.3 | 1.3 | 1.3 | 1.3 | 1.3 | 1.3 | |
| dispersing agent | | | | | | | | | | | | |
| Water | Distilled water | 76.0 | 66.0 | 63.0 | 58.0 | 70.0 | 70.0 | 76.0 | 48.0 | 76.0 | 74.0 | |
| Water-soluble | Triethylene glycol | 16.0 | 27.0 | 27.0 | 34.0 | 12.0 | 12.0 | — | — | — | 16.0 | |
| organic solvent | β-thiodiglycol | — | — | — | — | 10.0 | — | — | — | — | — | |
| | Diethylene glycol | — | — | — | — | — | 10.0 | — | — | — | — | |
| | Ethylene glycol | — | — | — | — | — | — | 16.0 | 44.0 | — | — | |
| | Glycerol | — | — | — | — | — | — | — | — | 16.0 | — | |
| Thickener | Polyacrylic acid | 0.5 | 0.5 | 0.5 | 0.5 | 0.5 | 0.5 | 0.5 | 0.5 | 0.5 | — | |
| | Sodium alginate | — | — | — | — | — | — | — | — | — | 2.7 | |
| pH regulator | Sodium hydroxide | 0.2 | 0.2 | 0.2 | 0.2 | 0.2 | 0.2 | 0.2 | 0.2 | 0.2 | — | |
| Evaluation of | Drying characteristics | A | A | B | B | A | A | A | C | A | A | C |
| printability | Operability after 3 days unused | A | A | A | A | A | A | C | A | C | C | A |
| | Operability after 10 days unused | A | A | A | A | A | A | — | C | — | — | A |
| | Operability after 1 month unused | A | A | A | A | A | A | — | — | — | — | A |

The inks of the examples all exhibited excellent drying characteristics of the printed material, and the printing machine was able to be operated even after sitting unused for 1 month.

In contrast, with the inks from the comparative examples 1 to 4, if the printing machine was left in an unused state, then it became inoperable within a short period of time. In the comparative example 2, a large quantity of water-soluble organic solvent was included in the ink, but the printability did not improve. Furthermore, despite containing a large quantity of water (66.0%), the emulsion ink of the comparative example 5 produced printed material for which the drying characteristics were slow.

1. A water-based ink for stencil printing, comprising an unsaturated carboxylic acid-based water-soluble polymer and triethylene glycol.

2. The water-based ink for stencil printing according to claim 1, further comprising β-thiodiglycol.

3. The water-based ink for stencil printing according to claim 1, further comprising diethylene glycol.

4. A stencil printing method that uses the water-based ink for stencil printing according to claim 1.

5. The water-based ink for stencil printing according to claim 2, further comprising diethylene glycol.

6. A stencil printing method that uses the water-based ink for stencil printing according to claim 2.

7. A stencil printing method that uses the water-based ink for stencil printing according to claim 3.
